(19) United States
(12) Patent Application Publication
(10) Pub. No.: US 2008/0068344 A1
(43) Pub. Date: Mar. 20, 2008

(54) Computer-assisted image editing method for handheld device

(75) Inventor: Hak Gyu Kim, Suwon-Si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (JP)

(21) Appl. No.: 11/725,734

(22) Filed: Mar. 20, 2007

(30) Foreign Application Priority Data
Sep. 20, 2006 (KR) 2006-90956

(51) Int. Cl. G06F 3/041; G06F 3/048

(52) U.S. Cl. 345/173; 715/781

(57) ABSTRACT

A computer-assisted image editing method for a handheld device is provided. A computer-assisted data editing method for a handheld device includes transmitting a target data corresponding to an area selected on a touch screen of the handheld device to a computer; displaying the target data on a display of the computer; editing the target data with assistance from the computer; transmitting the edited target data from the computer to the handheld device; and displaying the target data on the area selected on the touch screen. The computer-assisted image editing method for a handheld device is advantageous for manipulation of data using a touch screen while viewing the data on a large display device of a computer.

### PRIORITY

This application claims priority to an application entitled “COMPUTER-ASSISTED IMAGE EDITING METHOD FOR HANDHELD DEVICE” filed in the Korean Intellectual Property Office on Sep. 20, 2006 and assigned Serial No. 2006-90956, the contents of which are incorporated herein by reference.

### BACKGROUND OF THE INVENTION

1. Field of the Invention

The present invention relates to a handheld device and, in particular, a computer-assisted image editing method for a handheld device.

2. Description of the Related Art

Recently, handheld devices such as cellular phones, digital multimedia broadcasting (DMB) receivers, and portable multimedia players (PMP's) have been integrated with one another and with other auxiliary devices such as an electronic dictionary module, camera module, detachable memory, etc. in an advanced fashion. Such a handheld device can exchange multimedia data with a personal computer or a laptop computer through a wired link such as a universal serial bus (USB) or a wireless network link such as a wireless local area network.

The handheld device can also download various multimedia data including texts, still images, and motion pictures from a web server through Internet. Of course such multimedia data can be obtained using an inbuilt camcorder and a camera. The multimedia data obtained in various channels are stored in an internal or external memory and can be edited by keypad manipulation. Typically, a keypad is provided with a plurality of alphanumeric and special characters and navigation and function keys, which enable editing of the on-screen multimedia data.

However, the keypad of a handheld device is limited in size such that each key is assigned for inputting several alphanumeric and special characters. Also, the navigation keys are not appropriate for assisting the on-screen multimedia data editing. In a case of exchanging the multimedia data with other devices, the small size of keypad means that the user experiences manipulation inconvenience.

### SUMMARY OF THE INVENTION

The present invention has been made in an effort to solve the above problems, and it is an object of the present invention to provide an external computer-assisted image editing method for a handheld device that is capable of manipulation of an image on a computer screen using a touch screen of the handheld device.

It is another object of the present invention to provide a computer-assisted image editing method for a handheld device that is capable of improving user convenience by manipulating an image on a touchpad screen of the handheld device while viewing the image on a large computer screen.

In accordance with an aspect of the present invention, the above and other objects are accomplished by a computer-assisted data editing method for a handheld device. The computer-assisted data editing method includes transmitting a target data corresponding to an area selected on a touch screen of the handheld device to a computer; displaying the target data on a display of the computer; editing the target data with assistance from the computer; transmitting the edited target data from the computer to the handheld device; and displaying the target data on the area selected on the touch screen.

Preferably, the target data includes an aspect ratio of the touch screen.

Preferably, the target data is displayed in an editing window on the display.

Preferably, the computer-assisted data editing method further includes determining whether to transmit the edited target data to the handheld device.

Preferably, the edited target data includes line break information, font information, image size information, and data size information.

In accordance with another aspect of the present invention, the above and other objects are accomplished by a computer-assisted data editing method for a handheld device. The computer-assisted data editing method includes transmitting location information corresponding to an area selected on a touch screen of the handheld device to a computer; duplicating, at the computer, a target data on the basis of the location information; transmitting the target data from the computer to the handheld device; and displaying the target data in the area selected on the touch screen.

Preferably, the location information includes an aspect ratio of the touch screen.

Preferably, the target data includes line break information, font information, image size information, and data size information.

Preferably, the target data is displayed in a scaled-up or scaled-down manner on the touch screen.

### BRIEF DESCRIPTION OF THE DRAWINGS

The above and other objects, features and advantages of the present invention will be more apparent from the following detailed description in conjunction with the accompanying drawings, in which:

FIG. 1 is a block diagram illustrating a configuration of an image editing system according to the present invention;

FIG. 2 is a schematic view illustrating a display monitor sharing process of the image editing system of FIG. 1;

FIG. 3 is a flowchart of a data transmission procedure for a computer-assisted image editing method for a handheld device according to a first embodiment of the present invention;

FIG. 4 is a flowchart of a data transmission procedure for a computer-assisted image editing method for a handheld device according to the first embodiment of the present invention;

FIG. 5 is a message flow diagram of a computer-assisted image editing method according to the first embodiment of the present invention;

FIG. 6 is a system overview of a process for setting a data transmission mode of a computer-assisted image editing method according to the first embodiment of the present invention.

FIG. 7 is an illustration of a process for modifying a text at a computer in a computer-assisted image editing method according to the present invention.

FIG. 8 is an illustration of co-operation of a handheld device and a computer in a computer-assisted image editing method according to the present invention.

FIG. 9 is a flowchart of a data transmission procedure of a computer-assisted image editing method for a handheld device according to a second embodiment of the present invention;

FIG. 10 is a flowchart of a data transmission procedure of a computer-assisted image editing method for a handheld device according to the second embodiment of the present invention;

FIG. 11 is a message flow diagram of a computer-assisted image editing method according to the second embodiment of the present invention; and

FIG. 12 is an illustration of a process for setting a data transmission mode of a computer-assisted image editing method according to the second embodiment of the present invention.

### DETAILED DESCRIPTION OF PREFERRED EMBODIMENTS

Preferred embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention. Furthermore, the handheld device can be any of a portable phone, digital multimedia broadcasting receiver, portable multimedia player, etc., having a communication function, and the computer can be any of a personal computer and laptop computer having the identical communication function.

In a first embodiment of the present invention, an image editing system includes a handheld device having a touch screen, and a computer, that communicate with each other, the handheld device transmits an image to be edited at the computer, the image is edited in the computer, and is then returned to the handheld device. In a second embodiment of the present invention, an image is transmitted to a computer to enable control of a manipulation of the image while viewing the image on a large screen of the computer.

In the present invention, the handheld device has a touch screen as a display and can switch the touch screen between tablet mode for inputting commands through the touch screen and a data transmission mode for transmitting data to the computer, and the computer can operate in a data transmission mode for transmitting data to the handheld device.

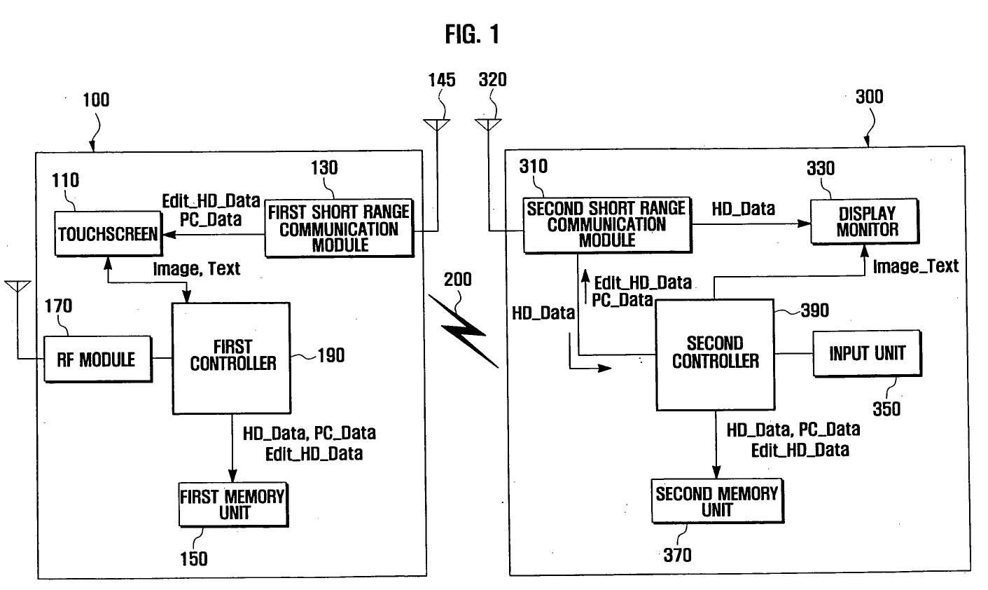

Referring to FIG. 1, the image editing system includes a handheld device 100 and a computer 300, which communicates with the handheld device 100 through wireless channel 200.

The handheld device 100 includes a touch screen 110, first short range communication module 130, first memory unit 150, radio frequency (RF) module 170, first controller 190, and first antenna 145.

Computer 300 includes a second short range communication module 310, display monitor 330, input unit 350, second memory unit 370, and second controller 390.

Touch screen 110 operates as a display and an input unit at the same time. Touch screen 110 is implemented on a rear surface of a liquid crystal display (LCD) and allows a user to operate the handheld device 100 with the user's finger or a stylus. Touch screen 110 includes a location scanner and an input data detector. The location scanner scans location information (Location_info) input through touch screen 110 and the input data detector detects text and image data being presented on touch screen 110. Touch screen 110 transmits the location information and text and image data to first controller 190.

First short range communication module 130 enables establishment of a wireless channel with second short range communication module 310 of computer 300 such that handheld device 100 and computer 300 can exchange data through the wireless channel. First short range communication module 130 is implemented on the basis of a wireless personal area network standard such as Bluetooth, Ultra Wide Band (UWB), Radio Frequency Identification (RFID), Zigbee, and RuBee. First short range communication module 130 can be provided with a Universal Serial Bus (USB) port. In this case, handheld device 100 can be connected to another device through a USB cable.

First memory unit 150 stores programs for controlling general operations of handheld device 100 and data generated in association with the programs.

RF module 170 enables establishment of a cellular communication channel for voice and data communication with other communication terminals under control of a base station.

First controller 190 controls cooperation between first short range communication module 130, first memory unit 150, and RF module 170. First controller 190 generates control signals including a communication request signal (Req_Sig) and a data transmission mode request signal (MS_Data_{—l Mode}_Sig), and transmits the control signals to computer 300. On the basis of the control signals computer 300 assigns a control of display monitor 330 to handheld device 100. In more detail, upon detecting an input of a tablet mode command, first controller 190 activates first short range communication module 130 and transmits a communication request message (Req_Sig) to computer 300. Next, if a data transmission command is input by the user, first controller 190 transmits the data transmission mode request message (MS_Data_Mode_Sig) and location information (Location_Info) to computer 300. The location information includes an aspect ratio of touch screen 110. First controller 190 also transmits target data (MS_Data) defined by coordinates and distances between the coordinates on the touch screen to computer 300 by means of first short range communication module 130. The target data includes margin information, which defines spaces outside the target data, and data type of the target data (for example, text and image). First controller 190 also transfers edited target data (Edit_MS_Data) received from computer 300 to the touch screen so as to replace the target data with the edited target data. The edited target data is the data modified in computer 300. The target data is modified while displayed in an editing window on display monitor 330. The editing window has a rectangular shape identical with touch screen 110 but proportionally enlarged in vertical and horizontal directions. The edited target data can be shown in the original size or enlarged size on touch screen 110.

The second short range communication module 310 of computer 300 enables establishment of the wireless channel with the first short range communication module. 130 of handheld device 100 such that computer 300 can transmit the edited target data to handheld device 100. Second short range communication module 310 is implemented on the basis of the identical wireless personal area network standard to that of first short range communication module 130.

Second short range communication module 310 can also be provided with a USB port. In this case, handheld device 100 and computer 300 can be connected through a USB cable.

Display monitor 330 displays an image on its screen under the control of second controller 390. Computer 300 activates the editing window on the screen of the display monitor in response to the data transmission request signal (MS_Data_Mode_Sig) and the location information (Location_Info) received from handheld device 100. The editing window is filled with the target data received from handheld device 100. While the target data is displayed in the editing window, a manipulation of a user's finger or a stylus on touch screen 110 of the handheld device is presented in the editing window.

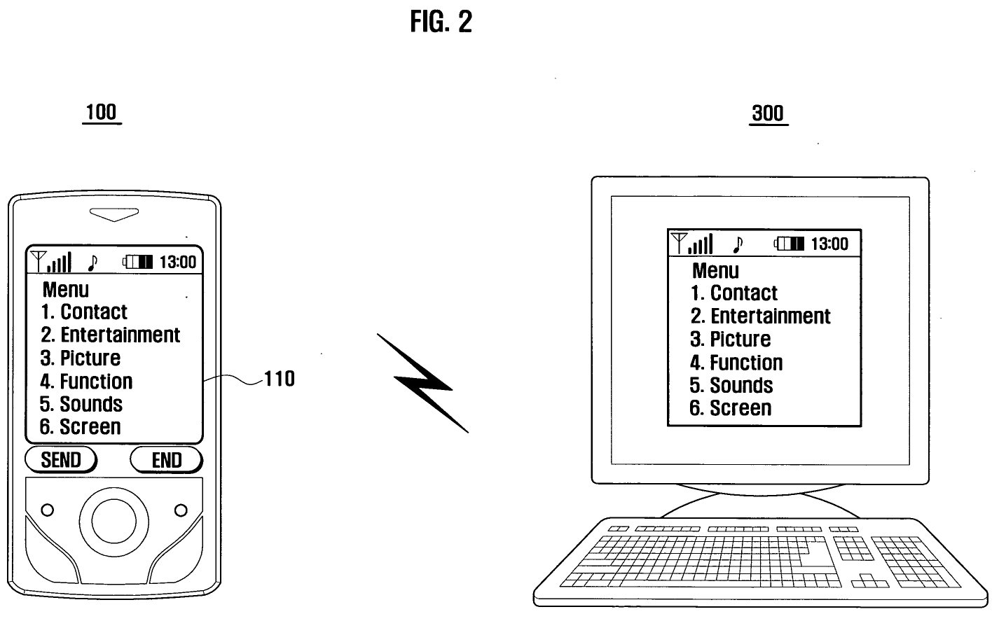

Input unit 350 includes a keyboard having a plurality of alphanumeric keys and various function keys and a mouse. Input unit 350 enables the user to input commands such that corresponding data is displayed through display monitor 330. If the editing window is activated, the control of the display monitor is shared by handheld device 100 such that the partial image presented in the editing window can be modified and stored under the control of the first controller of handheld device 100 or the second controller of computer 300 (see FIG. 2).

Second memory unit 370 stores a plurality of software programs for controlling various operations of computer 300 and data associated with the software programs.

Second controller 390 controls cooperation of second short range communication module 310, display monitor 330, input unit 350, and memory unit 370. In more detail, upon receiving the communication request signal (Req_Sig) from handheld device 100, second controller 390 establishes a wireless channel so as to exchange signals between handheld device 100 and computer 300. Second controller 390 enters the data transmission mode (MS_Data_Mode) in response to the data transmission mode request signal (PC_Data_Mode_Sig) received from handheld device 100. Second controller 390 activates the editing window on the screen of display monitor 330 on the basis of the location information (Location_info). Second controller 390 stores the target data received from handheld device 100 into second memory unit 370 and present the target data in the editing window. Second controller 390 directly transfers the text data to display monitor 330 and transfers the image data to display monitor 330 after processing. Second controller 390 also stores the edited target data (Edit_MS_Data) modified by manipulating input unit 350 and transmits the edited target data to handheld device 100. The edited target data includes informational line breaks, periods, fonts, and image size, as well as image data, such that the volume of the edited target data is larger than that of the target data.

A computer-assisted image editing method for a handheld device according to a first embodiment of the present invention is described hereinafter.

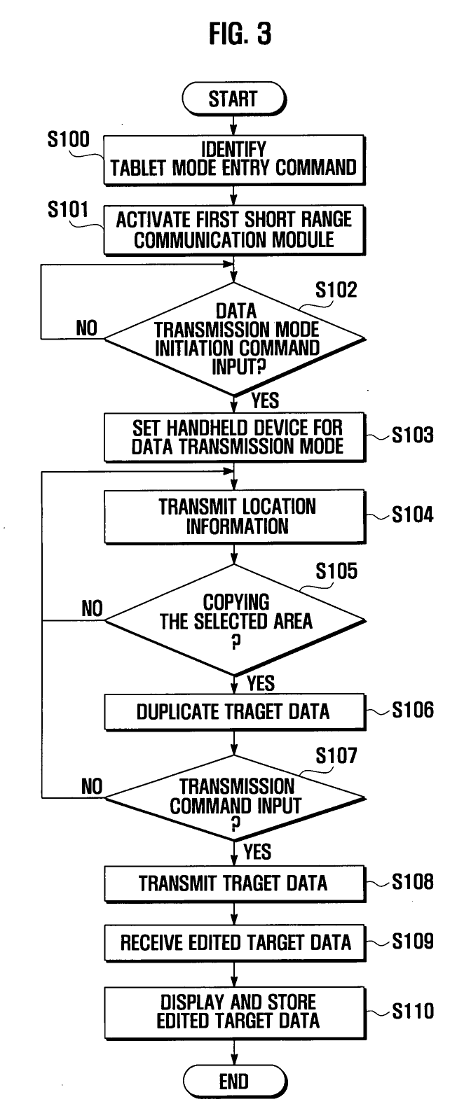

Referring to FIG. 3, first controller 190 of the handheld device 100 identifies that a tablet mode entry command is input for operating touch screen 110 in a tablet mode in step S100. When a tablet mode entry command is input, first controller 190 activates first short range communication module 130 in step S101 and transmits a communication request signal (Req_Sig) to computer 300 through first short range communication module 130.

Next, first controller 190 determines whether a data transmission mode initiation command is input in step S102. If a data transmission mode initiation command is input, first controller 190 transmits a data transmission mode request message (MS_Data_Mode_Sig) to computer 300 and sets the handheld device 100 for a data transmission mode (MS_Data_Mode) in step S103. First controller 190 detects a selection of an area or an object displayed on the touch screen, which is performed by a user's finger or a stylus, and transmits location information (Location_Info) defining a location of the selected area or object to computer 300 in step S104. The location information includes an aspect ratio of touch screen 110. First controller 190 then determines whether a confirmation command is input by the user for copying the selected area in step S105. If a confirmation command is input, first controller 190 duplicates target data corresponding to selected area in step S106.

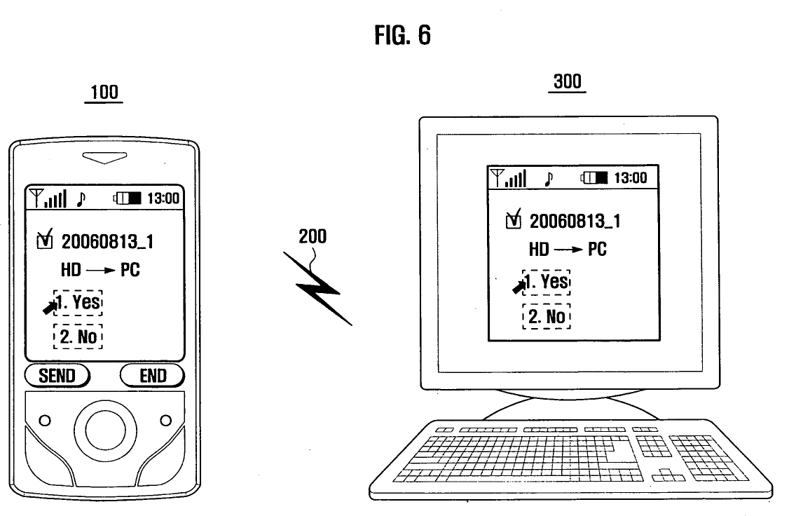

Next, first controller 190 determines whether a transmission command is input in step S107 (see FIG. 6). If a transmission command is input, first controller 190 transmits the target data to the computer in step S108. The target data is transmitted with additional information such as margins (top, bottom, left, and right margins) relative to the size of touch screen 110 and data type of the target data (for example, a text and an image).

The target data is modified at computer 300 in accordance with a remote manipulation through the touch screen or a direct manipulation through input unit 350 of the computer. First controller 190 then receives the edited target data from computer 300 in step S109 according to the user's commands. Next, first controller 190 replaces the target data with the modified target data and stores the screen image patched by the edited target data in first memory unit 150 in step S110. An editing window of display monitor 330 of the computer has an aspect ratio identical to that of touch screen 110 of handheld device 300, although its size is larger than that of touch screen 110. The modified target data can be scaled up and down in the touch screen.

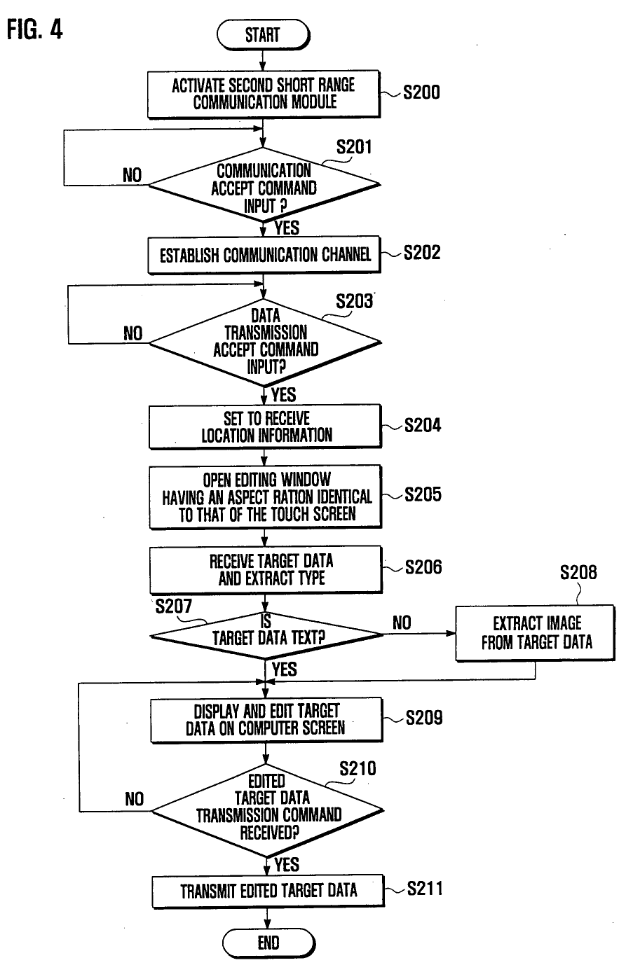

Referring to FIG. 4, when computer 300 is turned on, second controller 390 of computer 300 activates the second short range communication module 310 and awaits a communication request message (Req_Sig) from the handheld device 100 in step S200. When a communication request message is received, the second controller determines whether a communication accept command is input in step S201. If a communication accept command is input, second controller 390 establishes a communication channel with handheld device 100 and awaits a data transmission request message (MS_Data_Mode_Sig) through the communication channel in step S202. When a data transmission request message is received, second controller 390 determines whether a data transmission accepts command is input in step S203. If a data transmission accepts command is input, second controller 390 sets computer 300 for receiving the data transmitted from handheld device 100 and awaits location information (Location_Info) in step S204.

When location information is received, second controller 390 opens an editing window having an aspect ratio identical to that of touch screen 110 and awaits receipt of a target data from handheld device 100 in step S205. If second controller 390 receives a target data from handheld device 100 and extracts a type of the target data in step S206, and determines if the type of the target data is text in step S207. If the type of the target data is text, second controller 390 presents the target data as a text on the screen of display monitor 330 in step S209. If the type of the target data is not text, second controller 390 determines that the target data is an image and extracts an original image corresponding to the target data by scanning the target data in step S208 before presenting the target data on the screen at step S209.

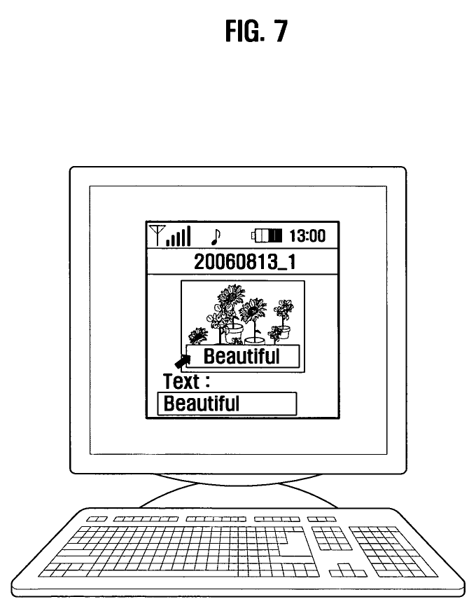

While presented on the screen, the target data can be edited. At this time, second controller 390 can control a size of the editing window presenting the target data while maintaining the aspect of the editing window in consideration of the margin and type information of the target data such that the target data can be displayed in a scaled-up or scaled-down manner. As shown in FIG. 7, the second controller 390 can control a coordination of the display monitor 330 and input unit 350 so as to enable input of commands for editing the target data by the user while viewing the editing status.

After the target data is completely edited, second controller 390 determines whether an edited target data transmission command is received from the handheld device 100 or input unit 350 in step S210. If an edited target data transmission command is received, second controller 390 transmits the edited target data to handheld device 100 through the communication channel in step S211. The edited target data can be transmitted with line break information, font information such as periods, and image related information such that a volume of the edited target data is probably larger than the original target data.

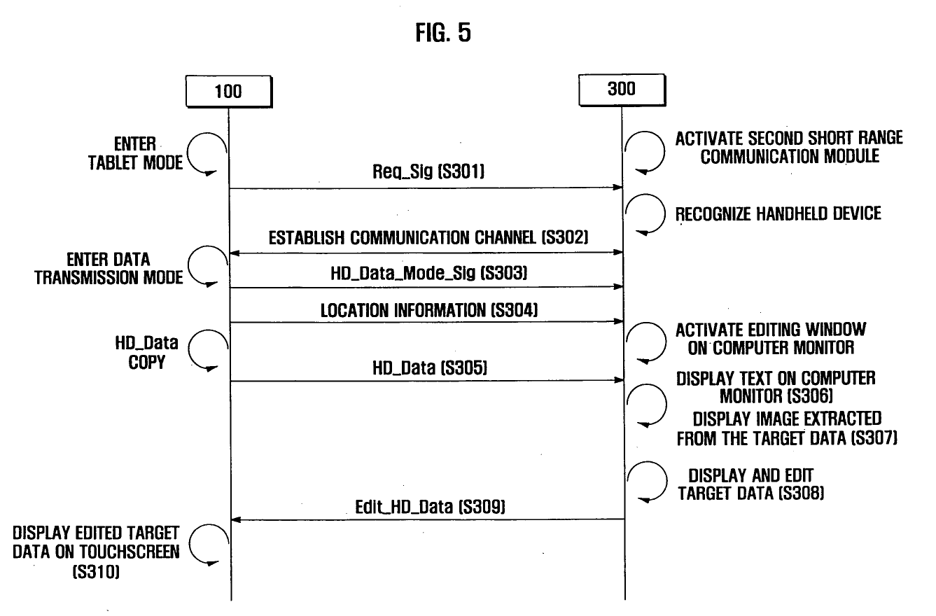

Referring to FIG. 5, after entering the tablet mode, handheld device 100 transmits a communication request message (Req_Sig) in step S301. Upon receiving the communication request message, computer 300 recognizes existence of handheld device 100 and establishes a communication channel by exchanging control signals in step S302.

If the communication channel is established, handheld device 100 enters a data transmission mode and transmits a data transmission request message (MS_Data_Mode_Sig) to computer 300 in step S303. Upon receiving the data transmission request message, computer 300 enters a data transmission mode. Subsequently, handheld device 100 transmits location information (Location_Info) to computer 300 in step S304. Upon receiving the location information, computer 300 activates an editing window, whose aspect ratio is identical to that of touch screen 110 of handheld device 100, on a screen of display monitor 330. Next, handheld device 100 extracts target data (MS_Data) corresponding to an area selected on touch screen 110 using a finger or a stylus and transmits the target data to computer 300 in step S305. If the target data is received, computer 300 analyzes the target data. As a result of the analysis, if the target data is text, computer 300 displays the target data in the editing window in step S306. If the target data is an image, computer 300 extracts an original image corresponding to the target data and then displays the extracted image in the editing window in step S307. The target data is edited according to user commands input through input unit 350 while the target data is displayed on the screen of display monitor 330 in step S308.

After the target data is completely edited, computer 300 displays a dialog box asking whether to transmit the edited target data. If an edited target data transmission command is input, computer 300 transmits the edited target data (Edit_MS_Data) to handheld device 100 in step S309. Upon receiving the edited target data, the handheld device replaces the original target data with the edited target data and displays the screen image patched by the edited target data in step S310.

As described above, in the image editing technique according to a first embodiment of the present invention, a handheld device selects and transmits an area or an object displayed on a touch screen of the handheld device to a computer having a large monitor screen as editable data such that it is possible to edit the editable data while viewing it in an enlarged copy on the large monitor screen. After editing the editable data, the edited data is returned to the handheld device and then replaced with the original editable data. Accordingly, the image editing technique according to the first embodiment of the present invention can solve the manipulation limitation caused by the small keypad of the handheld device and improve the user's convenience.

In the second embodiment of the present invention, the structure of the handheld device is identical with that of the handheld device of the first embodiment except for functions of the touch screen and the first controller. Accordingly, only the functions of the touch screen and the first controller are described in the second embodiment.

The touch screen operates as a display and an input unit at the same time. Touch screen 110 is implemented on a rear surface of a liquid crystal display (LCD) and allows a user to operate handheld device 100 with a finger or a stylus. Touch screen 110 includes a location scanner that scans location information (Location_Info) of the data input through touch screen 110 and transfers the scanned location information to first controller 190.

First controller 190 controls cooperation between first short range communication module 130, first memory unit 150, and RF unit 170. First controller 190 generates control signals including a communication request signal (Req_Sig) and a data transmission mode request signal (PC_Data_Mode_Sig) so as to control display monitor 330 of computer 300. In more detail, upon detecting an input of a tablet mod command, first controller 190 activates first short range communication module 130 and transmits a communication request message to computer 300. Next, if a data transmission command (PC_Data_Mode) is input by the user, first controller 190 transmits the data transmission mode request signal (PC_Data_Mode_Signal) and location information (Location_Info) to computer 300. The location information includes an aspect ratio of touch screen 110. First controller 190 also transmits target data (PC_Data) defined by coordinates and distances between the coordinates to the touch screen from computer 300 by means of first short range communication module 130. The target data includes margin information, which defines spaces outside the target data, and data type of the target data (for example, text and image). First controller 190 controls in order for touch screen 110 to display edited target data received from computer 300. The edited target data includes information on line breaks, periods, fonts, and image size, as well as the image data, such that the volume of the edited target data is larger than that of the target data.

Second short range communication module 310 of computer 300 establishes a communication channel 200 with first short range communication module 130 of handheld device 100 so as to enable exchange of signals between the handheld device 100 and computer 300. Second short range communication module 310 is implemented on the basis of the identical wireless personal area network standard to that of first short range communication module 130. Second short range communication module 310 can also be provided with a USB port. In the case that both first short range communication module 130 of handheld device 100 and second short range communication module 310 are provided with the USB ports, handheld device 100 and computer 300 can be connected through a USB cable.

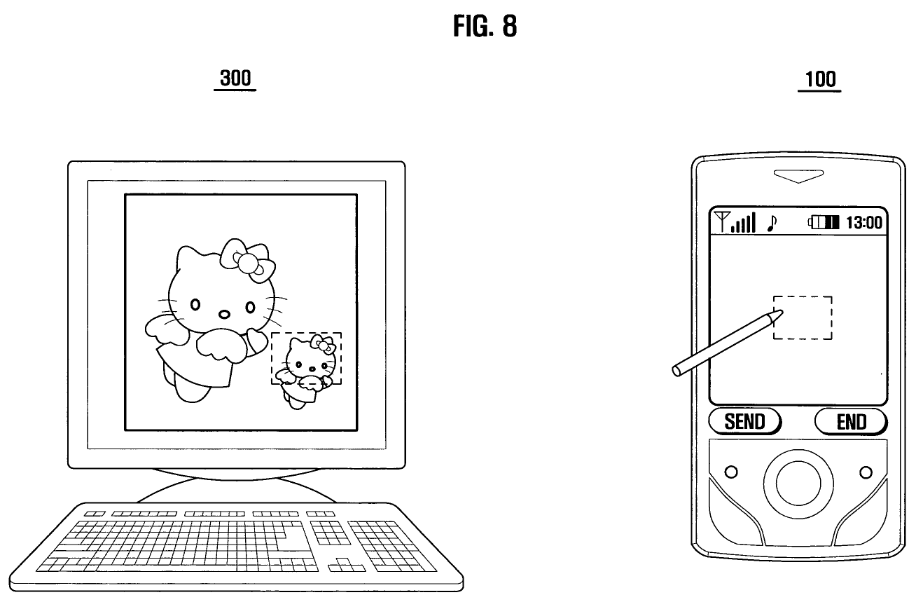

Display monitor 330 is activated under the control of second controller 390. For example, if a data transmission mode entry signal (PC_Data_Mode) is output from second controller 390 and the location information (Location_Info) is received from handheld device 100 to display monitor 330, a cursor moves in accordance with the location information on the screen of display monitor 330, as shown in FIG. 8. That is, the cursor moves on the screen of display monitor 330 to reproduce a corresponding movement of a finger or a stylus on the touch screen.

Input unit 350 includes a keyboard having a plurality of alphanumeric keys and various function keys and a mouse. Input unit 350 enables the user to input commands such that corresponding data is displayed through display monitor 330.

Second memory unit 370 stores a plurality of software programs for controlling various operations of computer 300 and data associated with the software programs.

Second controller 390 controls a cooperation of second short range communication module 310, display monitor 330, input unit 350, and the memory unit.

In more detail, upon receiving the communication request signal (Req_Sig) from handheld device 100, second controller 390 establishes a wireless channel so as to exchange signals between handheld device 100 and computer 300. Second controller 390 enters the data transmission mode (PC_Data_Mode) in response to the data transmission mode request signal (PC_Data_Mode_Sig) received from handheld device 100. Second controller 390 activates the editing window on the screen of display monitor 330 on the basis of the location information (Location_Info). Second controller 390 stores the target data received from handheld device 100 into second memory 370 and present the target data in the editing window. Second controller 390 directly transfers the text data to display monitor 330 and transfers the image data to display monitor 330 after processing. Second controller 390 also stores the edited target data (Edit_PC_Data) modified by manipulating input unit 350 and transmits the edited target data to handheld device 100. The edited target data includes information on line breaks, periods, fonts, and image size, as well as image data, such that the volume of the edited target data is larger than that of the target data.

A computer-assisted image editing method for a handheld device according to a second embodiment of the present invention is described hereinafter.

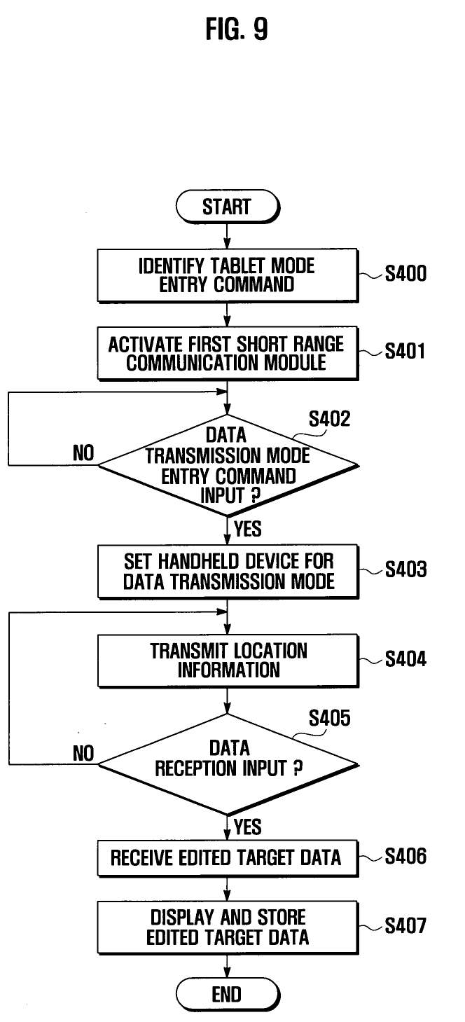

FIG. 9 is a flowchart of a data transmission procedure for a computer-assisted image editing method for a handheld device according to a second embodiment of the present invention.

Referring to FIG. 9, first controller 190 of the handheld device 100 identifies that a tablet mode entry command is input for operating touch screen 110 in a tablet mode in step S400. When a tablet mode entry command is input, first controller 190 activates the first short range communication module 130 in step S401 and transmits a communication request signal (Req_Sig) to computer 300 through first short range communication module 130.

Next, first controller 190 determines whether a data transmission mode entry command (PC_Data_Mode) is input in step S402. If a data transmission mode entry command is input, first controller 190 transmits a data transmission mode request signal (PC_Data_Mode_Sig) to computer 300 and sets handheld device 100 for a data transmission mode in step S403. First controller 190 detects a selection of an area or an object displayed on the touch screen, which is performed by a user's finger or a stylus, and transmits location information (Location_Info) defining a location of the selected area or object to the computer 300 (S404). The location information includes an aspect ratio of the touch screen 110.

Upon receiving a data transmission request signal (PC_Data) from the computer 300, the first controller 190 determines whether a data reception accept command is input (S405). If a data reception accepts command is input, the first controller 190 receives the edited target data (PC_Data) transmitted from the computer 300 (S406). The edited target data includes information on line breaks, periods, fonts, and image size, as well as the image data, such that the volume of the edited target data is larger than that of the target data. Upon receiving the edited target data, the first controller 190 displays the edited target data on the touch screen 110 and stores the screen image patched by the edited target data into the first memory unit 150 in step S407.

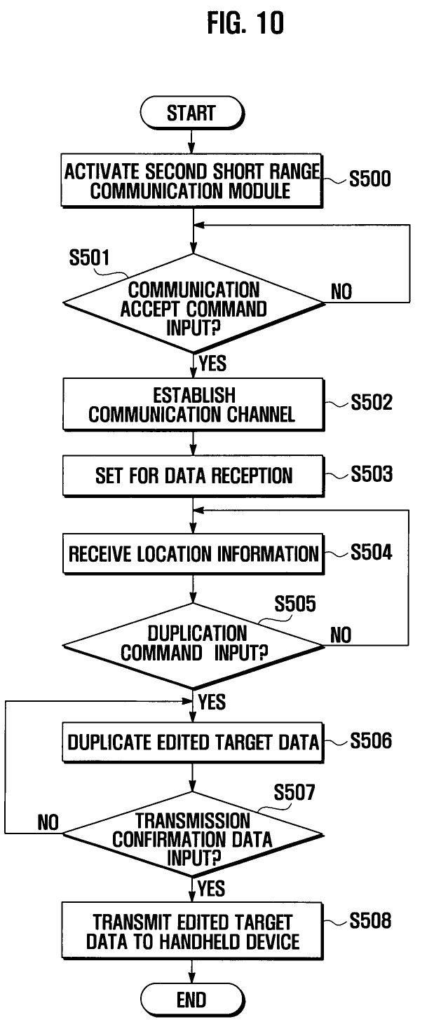

FIG. 10 is a flowchart illustrating steps for a computer in a data transmission procedure of a computer-assisted image editing method for a handheld device according to a second exemplary embodiment of the present invention.

Referring to FIG. 10, when the computer 300 is turned on, the second controller 390 of the computer 300 activates the second short range communication module 310 and awaits a communication request message (Req_Sig) from the handheld device 100 in step S500.

When a communication request message is received, the second controller 390 determines whether a communication accepts command is input (S501). If a communication accepts command is input, the second controller 390 establishes a communication channel with the handheld device 100 and awaits receipt of a data transmission request signal (PC_Data_Mode_Sig) through the communication channel (S502).

When a data transmission request message is received, the second controller 390 sets the computer 300 for receiving the data transmitted from the handheld device 100 S503. Subsequently, location information (Location_Info) is received from the handheld device 100 (S504), and the second controller 390 moves a cursor on the basis of the location information as shown in FIG. 8. The location information includes information on the aspect ratio of the touch screen 110 so as to display the target data on a screen having a different size.

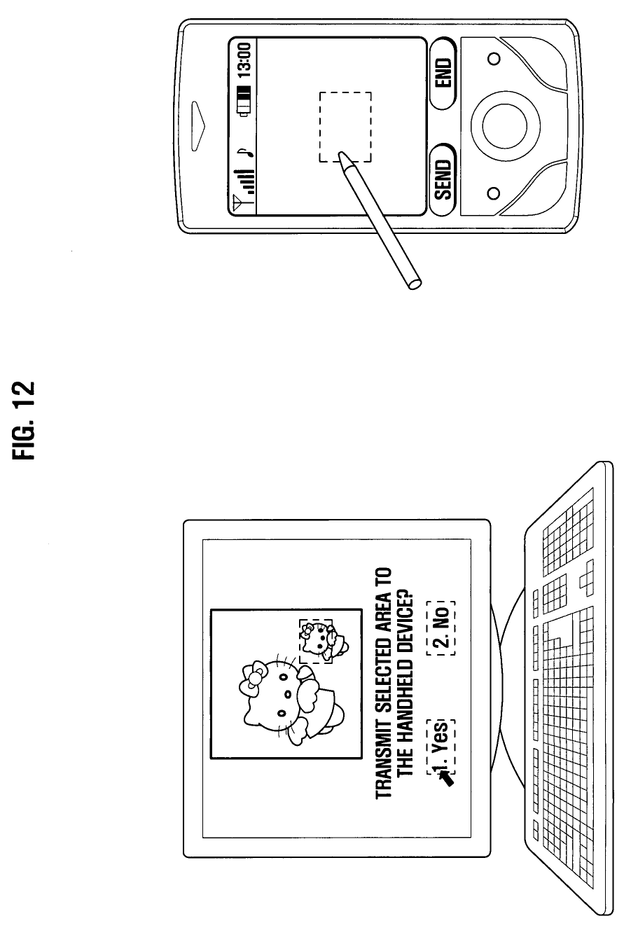

Next, the second controller 390 determines whether a duplication command is input in step (S505). If a duplication command is input, the second controller 390 duplicates data (PC_Data) corresponding to the location information in step S506 and displays a dialog box asking whether to transmit the duplicated data on the screen of the display monitor as shown in FIG. 12, which illustrates a process for setting a data transmission mode in the present embodiment. The second controller 390 determines whether a confirmation command is input through the dialog box in step S507, and, if a confirmation command is input, transmits the duplicated data to the handheld device in step S508.

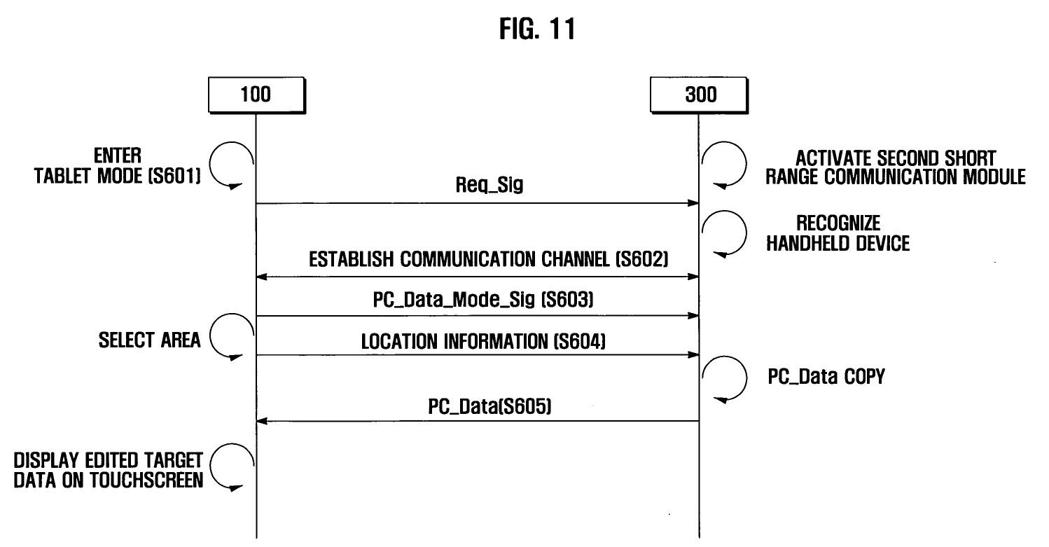

FIG. 11 is a message flow diagram illustrating a computer-assisted image editing method according to a second exemplary embodiment of the present invention.

Referring to FIG. 11, after entering the tablet mode, the handheld device 100 transmits a communication request message (Req_Sig) in step S601. Upon receiving the communication request message, the computer 300 recognizes existence of the handheld device 100 and establishes a communication channel by exchanging control signals in step S602.

If the communication channel is established, the handheld device 100 enters a data transmission mode and transmits a data transmission request signal (PC_Data_Mode_Sig) to the computer 300 in step S603. Upon receiving the data transmission request message, the computer 300 enters a data transmission mode. Next, the handheld device 100 transmits location information (Location_Info) to the computer 300 through the communication channel in step S604. Upon receiving the location information, the computer 300 duplicates data corresponding to the location information as an edited target data (PC_Data) and transmits the edited target data to the handheld device 100 in step S605. The location data includes information on the aspect ratio of the touch screen 110 so as to enable display of the target data on the screen having a different size. When the edited target data is received, the handheld device 100 displays the edited target data on the touch screen 110 and stores the screen image patched by the edited target data into the first memory unit 150 in step S606. The edited target data includes information on line breaks, periods, fonts, and image size, as well as image data, such that the volume of the edited target data is larger than that of the target data.

As described above, in the image editing technique according to a second exemplary embodiment of the present invention, a handheld device utilizes a touch screen as an input device and is connected to a computer having a display monitor through a short range communication channel such that the handheld device can manipulate data while displaying on the display monitor of the computer. Also, the handheld device can conveniently manipulate an image under the assistance of the computer.

As described above, the computer-assisted image editing method for a handheld device according to the present invention is advantageous for manipulation of data using a touch screen while viewing the data on a large display device of a computer.

Also, the computer-assisted image editing method of the present invention enables modification of data while a user views the data on a large external display device and manipulates the data on a touch screen, whereby it is possible to improve user convenience.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A computer-assisted data editing method for a handheld device, comprising:
transmitting a target data corresponding to an area selected on a touch screen of the handheld device to the computer;
displaying the target data on a display of the computer;
editing the target data with assistance from the computer;
transmitting the edited target data from the computer to the handheld device; and
displaying the target data on the area selected on the touch screen.

2. The computer-assisted data editing method of claim 1, wherein the target data comprises an aspect ratio of the touch screen.

3. The computer-assisted data editing method of claim 1, wherein the target data is displayed in an editing window on the display.

4. The computer-assisted data editing method of claim 1, further comprising determining whether to transmit the edited target data to the handheld device.

5. The computer-assisted data editing method of claim 1, wherein the edited target data comprises line break information, font information, image size information, and data size information.

6. A computer-assisted data editing method for a handheld device, comprising:
transmitting location information corresponding to an area selected on a touch screen of the handheld device to the computer;
duplicating, at the computer, a target data on the basis of the location information;
transmitting the target data from the computer to the handheld device; and
displaying the target data in the area selected on the touch screen.

7. The computer-assisted data editing method of claim 6, wherein the location information comprises an aspect ratio of the touch screen.

8. The computer-assisted data editing method of claim 6, wherein the target data comprises line break information, font information, image size information, and data size information.

9. The computer-assisted data editing method of claim 6, wherein the target data is displayed in a scaled-up or scaled-down manner on the touch screen.
